(19) United States
(12) Patent Application Publication
(10) Pub. No.: US 2024/0240516 A1
(43) Pub. Date: Jul. 18, 2024

(54) BLIND WITHOUT PULL CORD AND RAISING DEVICE

(71) Applicant: FRESH SPRING INTERNATIONAL,INC., New Taipei City (TW)

(72) Inventor: Chih-Ming HSIEH, New Taipei City (TW)

(73) Assignee: FRESH SPRING INTERNATIONAL,INC., New Taipei City (TW)

(21) Appl. No.: 18/208,706

(22) Filed: Jun. 12, 2023

(30) Foreign Application Priority Data
Jan. 18, 2023 (TW) 112102176

(51) Int. Cl. E06B 9/322; E06B 9/324

(52) U.S. Cl. CPC E06B 9/322; E06B 9/324

(57) ABSTRACT

A blind without pull cord and a raising device. The blind includes a blind structure and at least one raising device. The blind structure has a fixed side and a movable side opposite to each other. The raising device includes a housing, a retracting component and a raising cord. The housing is connected to the movable side. The retracting component is rotatably disposed on the housing. Two opposite ends of the raising cord are connected to the blind structure and the retracting component, respectively. The retracting component is configured to raise the movable side relative to the fixed side via the raising cord.

### CROSS-REFERENCE TO RELATED APPLICATIONS

This non-provisional application claims priority under 35 U.S.C. § 119(a) on Patent Application No(s). 112102176 filed in Taiwan, R.O.C. on Jan. 18, 2023, the entire contents of which are hereby incorporated by reference.

### TECHNICAL FIELD

The disclosure relates to a blind without pull cord and a raising device, more particularly to a blind without pull cord and a raising device each include a retracting component.

### BACKGROUND

In order to control the amount of the light passing through the window, slats of a blind are lowered/raised by a raising mechanism. In detail, the amount of the light passing through the window can be decreased by lowering the slats via the raising mechanism, and the amount of the light passing through the window can be increased by raising the slats via the raising mechanism.

However, in the conventional blind, the raising mechanism is disposed in a headrail. Since other components such an angle adjusting mechanism are required to be disposed in the headrail besides the raising mechanism, the space in the headrail for accommodating the raising mechanism is limited. Thus, in order to increase the space utilization of the headrail, conventional raising mechanism usually includes various expensive and complex machine elements such as gears, which increases the manufacture cost of the blind.

### SUMMARY

The disclosure provides a blind without pull cord and a raising device with reduced manufacture cost.

One embodiment of this disclosure provides a blind without pull cord including a blind structure and at least one raising device. The blind structure has a fixed side and a movable side opposite to each other. The raising device includes a housing, a retracting component and a raising cord. The housing is connected to the movable side. The retracting component is rotatably disposed on the housing. Two opposite ends of the raising cord are connected to the blind structure and the retracting component, respectively. The retracting component is configured to raise the movable side relative to the fixed side via the raising cord.

Another embodiment of this disclosure provides a raising device configured to be connected to a movable side of a blind structure and including a housing, a retracting component and a raising cord. The housing is configured to be connected to the movable side. The retracting component is rotatably disposed on the housing. Two opposite ends of the raising cord are connected to the blind structure and the retracting component, respectively. The retracting component is configured to raise the movable side via the raising cord.

According to the blind without pull cord and the raising device disclosed by above embodiments, since the housing of the raising device is connected to the movable side, the structure of the raising device is not limited by the headrail of the blind structure that is located at the fixed side. Therefore, the raising device is allowed to raise the movable side by the retracting component that is cheap and simple in structure without using various expensive and complex machine elements such as gears. Thus, the manufacture cost of the blind is reduced.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a blind without pull cord according to an embodiment of the disclosure;

FIG. 2 is a partially enlarged perspective view of the blind in FIG. 1;

FIG. 3 is a perspective exploded view of a raising device of the blind in FIG. 1 omitting a raising cord;

FIG. 4 is a perspective view of the raising device of the blind in FIG. 1 omitting a cover;

FIG. 5 is a perspective cross-sectional view of the raising device of the blind in FIG. 1 omitting the cover;

FIG. 6 is a perspective view showing a raising/lowering mode of the blind in FIG. 1;

FIG. 7 is a perspective view of the raising device of the blind in FIG. 6 omitting the cover; and

FIG. 8 is a perspective cross-sectional view of the raising device of the blind in FIG. 6 omitting the cover.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

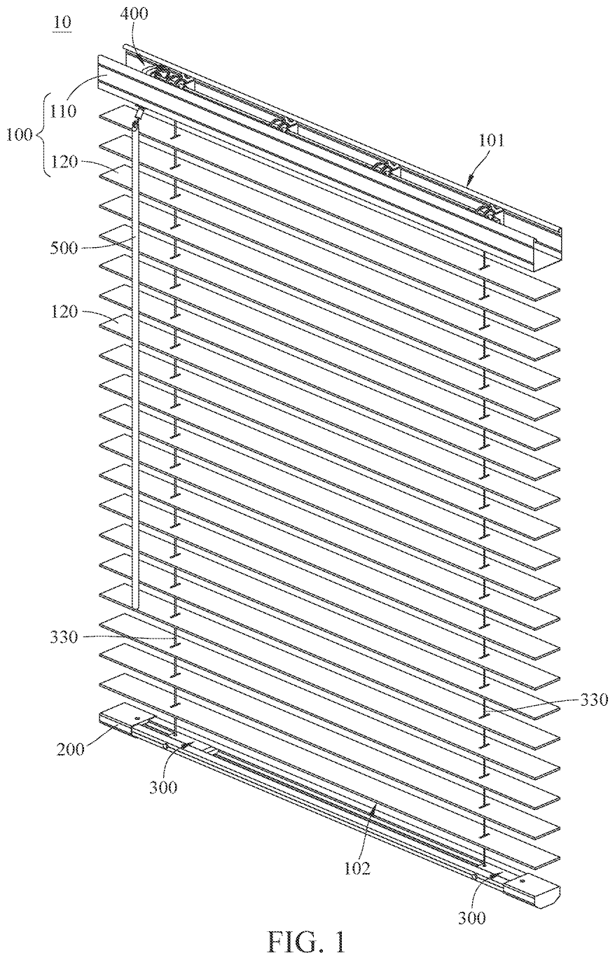

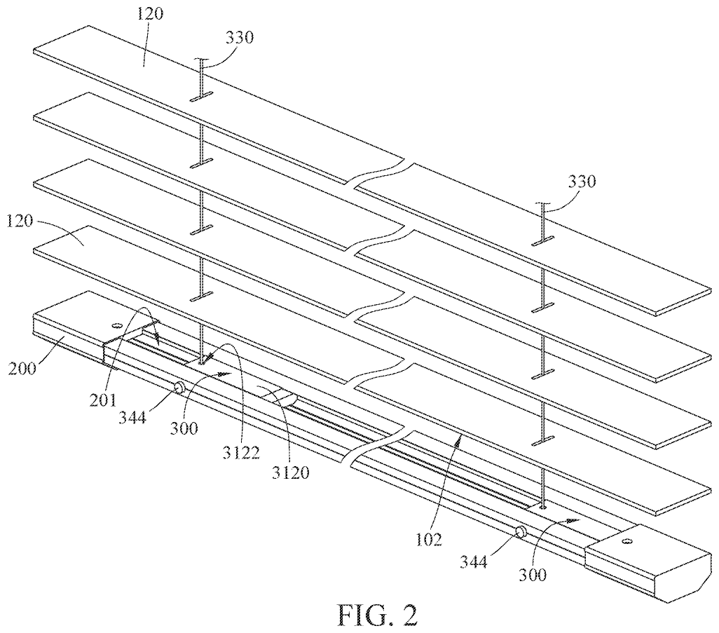

Please refer to FIGS. 1 and 2. FIG. 1 is a perspective view of a blind 10 without pull cord according to an embodiment of the disclosure. FIG. 2 is a partially enlarged perspective view of the blind 10 in FIG. 1.

In this embodiment, the blind 10 without pull cord includes a blind structure 100, a handheld plate 200, two raising devices 300, an angle adjustment assembly 400 and an angle adjustment rod 500. The blind structure 100 has a fixed side 101 and a movable side 102 opposite to each other. The movable side 102 is allowed to be raised or lowered relative to the fixed side 101. In this embodiment, the blind structure 100 includes a headrail 110 and a plurality of slats 120. The slats 120 are connected to a side of the headrail 110. The fixed side 101 is, for example, a side of the headrail 110 that is located farthest away from the slats 120. The movable side 102 is, for example, a side of an assembly of the slats 120 that is located farthest away from the headrail 110.

The handheld plate 200 is connected to the headrail 110 via the slats 120. The slats 120 are located between the headrail 110 and the handheld plate 200. The two raising devices 300 are partially disposed in an accommodation recess 201 of the handheld plate 200, and are spaced apart from each other.

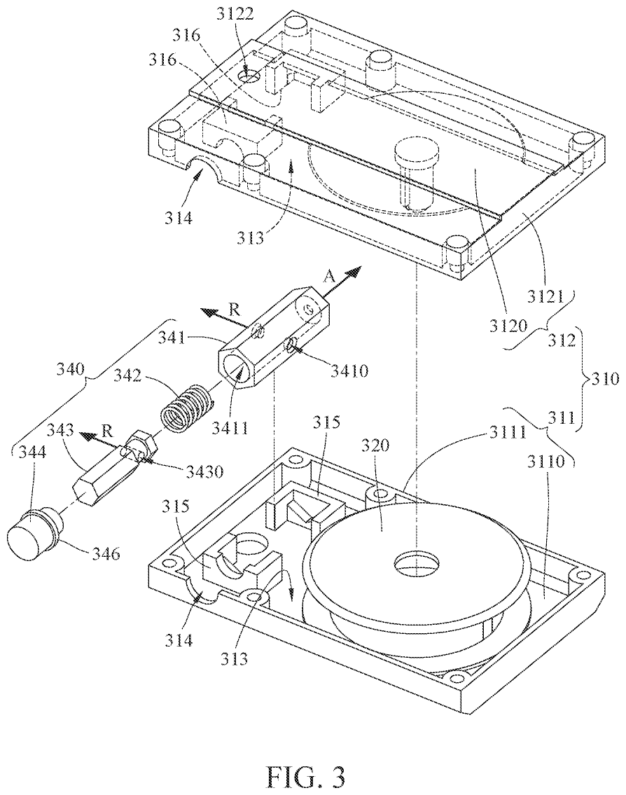

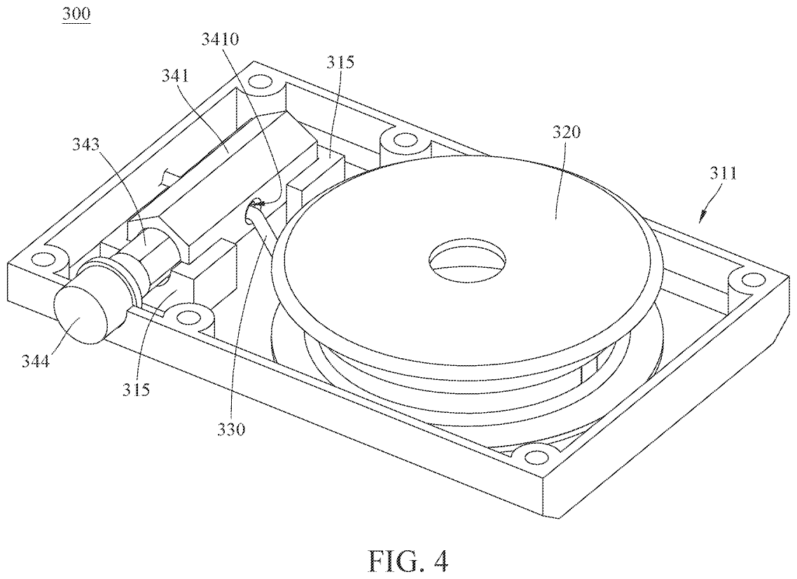

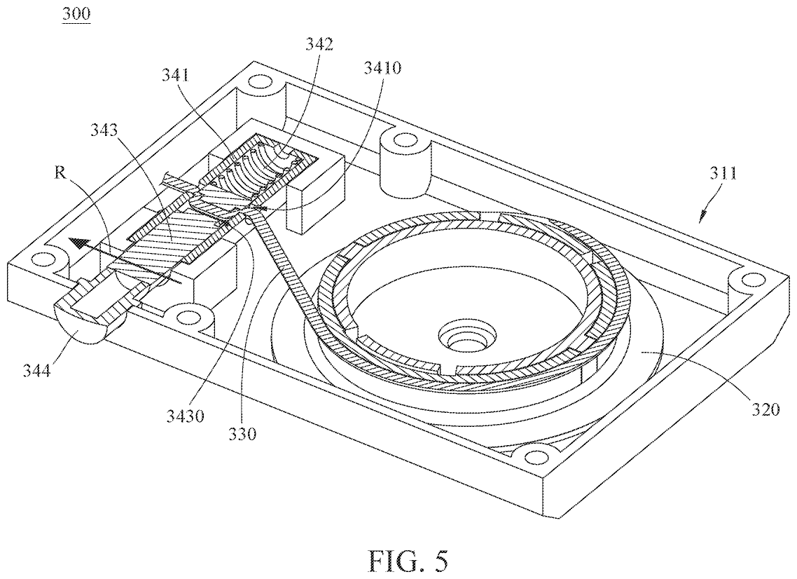

Since the two raising devices 300 are similar in structure and are manipulated in a similar manner, only the structure and manipulation of one of the two raising devices 300 will be described in detail hereinafter. Please refer to FIGS. 3 to 5. FIG. 3 is a perspective exploded view of the raising device 300 of the blind 10 in FIG. 1 omitting a raising cord 330. FIG. 4 is a perspective view of the raising device 300 of the blind 10 in FIG. 1 omitting a cover 312. FIG. 5 is a perspective cross-sectional view of the raising device 300 of the blind 10 in FIG. 1 omitting the cover 312.

In this embodiment, the raising device 300 includes a housing 310, a retracting component 320, the raising cord 330 and a positioning assembly 340. In this embodiment, the housing 310 includes a base 311 and the cover 312. The base 311 includes a bottom plate 3110 and a first side peripheral plate 3111 standing on the bottom plate 3110. The cover 312 includes a top plate 3120 and a second side peripheral plate 3121 standing on the top plate 3120. The second side peripheral plate 3121 is stacked on the first side peripheral plate 3111 so that the base 311 and the cover 312 together form an accommodation space 313 therebetween. The first side peripheral plate 3111 and the second side peripheral plate 3121 together form a mounting through hole 314 connected to the accommodation space 313. The top plate 3120 has a cord hole 3122 connected to the accommodation space 313. In addition, as shown in FIG. 2, the cord hole 3122 of the top plate 3120 are exposed to the outside from the handheld plate 200.

The retracting component 320 is rotatably disposed on the bottom plate 3110 and is located in the accommodation space 313. Two opposite ends of the raising cord 330 are connected to the blind structure 100 and the retracting component 320, respectively. Also, the retracting component 320 is configured to raise the movable side 102 relative to the fixed side 101 via the raising cord 330. In this embodiment, for example, the retracting component 320 includes a spiral torsion spring (not shown), and two opposite ends of the raising cord 330 are fixed to the headrail 110 and the spiral torsion spring of the retracting component 320, respectively. The raising cord 330 connects, for example, all the slats 120, and is disposed through the cord hole 3122. The spiral torsion spring of the retracting component 320 is configured to store elastic potential energy and to retract the raising cord 330 on the retracting component 320 by releasing the stored elastic potential energy.

The positioning assembly 340 is disposed in the housing 310 and configured to position or release the raising cord 330. In detail, in this embodiment, the positioning assembly 340 includes a fixed barrel 341, an elastic component 342, a movable barrel 343 and a trigger 344. The fixed barrel 341 is fixed to the housing 310 by being clamped between two mounting plates 315 standing on the bottom plate 3110 and two mounting plates 316 standing on the top plate 3120. The fixed barrel 341 is located in the accommodation space 313. The fixed barrel 341 has a first through hole 3410 and an accommodation through hole 3411. The first through hole 3410 extends along a radial direction R of the fixed barrel 341. The accommodation through hole 3411 extends along an axial direction A of the fixed barrel 341, and is connected to the first through hole 3410.

The elastic component 342 and the movable barrel 343 are located in the accommodation space 313. The movable barrel 343 is disposed through the accommodation through hole 3411 of the fixed barrel 341. That is, in this embodiment, the fixed barrel 341 is sleeved on the movable barrel 343. The elastic component 342 is, for example, a compression spring. Two opposite ends of the elastic component 342 are fixed to, for example, the mounting plates 315 and 316 at the same side and an end of the movable barrel 343, respectively. Thus, the movable barrel 343 is movably disposed on the housing 310 along the axial direction A of the fixed barrel 341. The movable barrel 343 has a second through hole 3430 extending along a radial direction R of the movable barrel 343. Note that since the fixed barrel 341 and the movable barrel 343 are coaxial to each other in this embodiment, the fixed barrel 341 and the movable barrel 343 have the same axial direction A and the same radial direction R.

As shown in FIG. 5, the raising cord 330 is disposed through the first through hole 3410 and the second through hole 3430, and the first through hole 3410 and the second through hole 3430 are misaligned with each other along the radial direction R of the fixed barrel 341. Thus, the raising cord 330 is bent and thus is positioned by the positioning assembly 340. Specifically, when the first through hole 3410 and the second through hole 3430 are misaligned with each other, the elastic force generated by the spiral torsion spring of the retracting component 320 is unable to straighten the bent raising cord 330.

The trigger 344 is, for example, a button and disposed through the mounting through hole 314. The trigger 344 rests on a side of the movable barrel 343 that is located farthest away from the elastic component 342 so as to be configured to force the positioning assembly 340 to release the raising cord 330. In this embodiment, the trigger 344 has a blocking protrusion 346. The blocking protrusion 346 is located in the accommodation space 313, and is configured to prevent the trigger 344 from being detached from the housing 310 by resting on the first side peripheral plate 3111 and the second side peripheral plate 3121. Further, as shown in FIG. 2, the trigger 344 is exposed to the outside from the handheld plate 200.

Please refer to FIG. 1 again, the angle adjustment assembly 400 is disposed in the headrail 110. The angle adjustment rod 500 is connected to the angle adjustment assembly 400. When the angle adjustment rod 500 is rotated, the angle adjustment rod 500 is configured to adjust the angle of each slat 120 by the angle adjustment assembly 400.

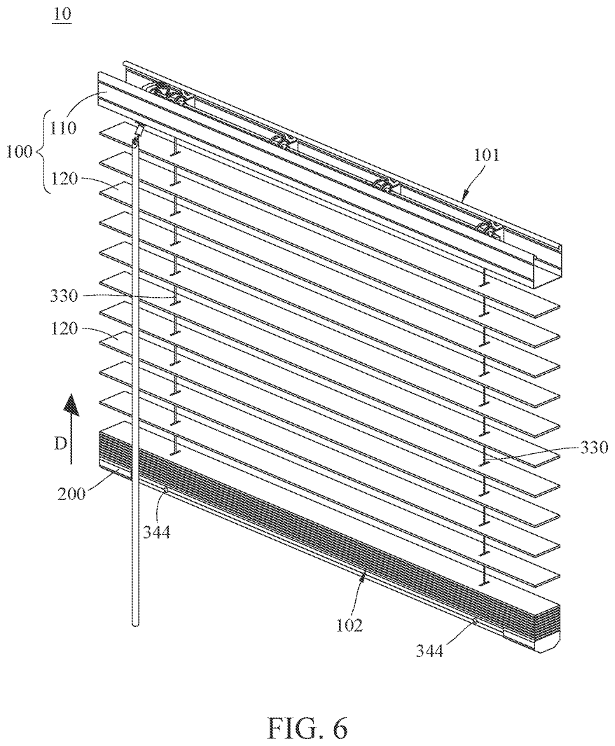

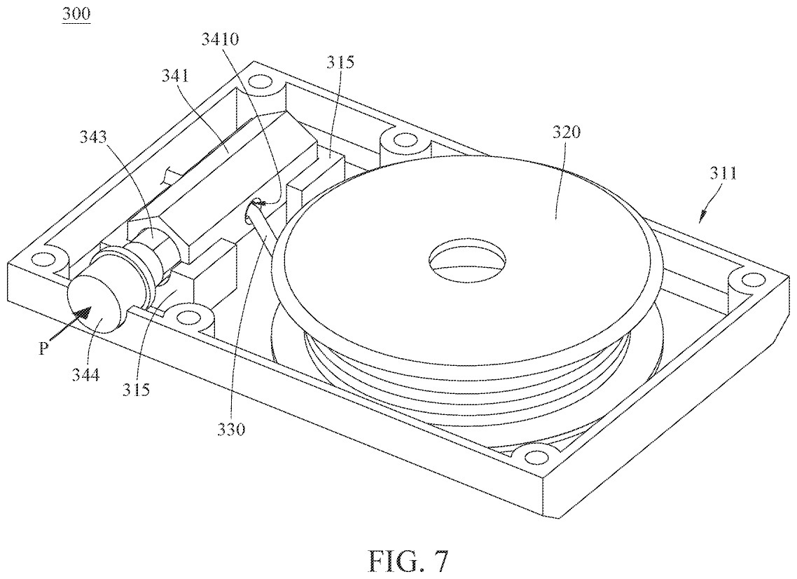

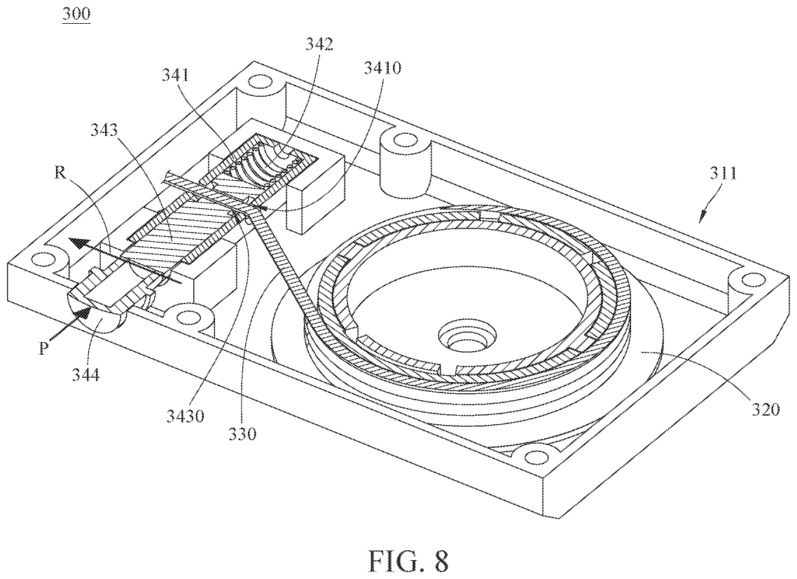

Hereinafter, the manipulation of the raising device 300 according to the disclosure will be described. Please refer to FIGS. 6 to 8. FIG. 6 is a perspective view showing a raising/lowering mode of the blind 10 in FIG. 1. FIG. 7 is a perspective view of the raising device 300 of the blind 10 in FIG. 6 omitting the cover 312. FIG. 8 is a perspective cross-sectional view of the raising device 300 of the blind 10 in FIG. 6 omitting the cover 312.

When the trigger 344 is pushed along a pushing direction P denoted in FIGS. 7 and 8, the movable barrel 343 is pushed by the trigger 344 and thus is moved toward the elastic component 342. Then, the first through hole 3410 and the second through hole 3430 are aligned with each other along the radial direction R of the fixed barrel 341 so that the positioning assembly 340 releases the raising cord 330. Specifically, when the first through hole 3410 and the second through hole 3430 are aligned with each other, the elastic force generated by the spiral torsion spring of the retracting component 320 straightens the bent raising cord 330. Then, the positional restriction of the raising cord 330 by the positioning assembly 340 is therefore released. In this way, the blind 10 is in the raising/lowering mode. When the blind 10 is in the raising/lowering mode, the elastic force generated by the spiral torsion spring of the retracting component 320 further forces the raising cord 330 to be retracted back to the retracting component 320, thereby raising at least part of the slats 120 relative to the fixed side 101 along a raising direction D as shown in FIG. 6.

Note that when the blind 10 is in the raising/lowering mode, the handheld plate 200 may be pulled along a direction opposite to the raising direction D while the trigger 344 is pushed. Specifically, the elastic force generated by the spiral torsion spring of the retracting component 320 can be overcome by the pulling force, and the slats 120 can be further lowered by the pulling force along the direction opposite to the raising direction D.

Note that the raising device 300 according to the disclosure is not limited to include the positioning assembly 340 configured to position or release the raising cord 330. In other embodiments, if the blind structure includes other positioning means, the raising device may not include the positioning assembly.

In addition, in this embodiment, the fixed barrel 341 is sleeved on the movable barrel 343, but the disclosure is not limited thereto. In other embodiments, the movable barrel may be sleeved on the fixed barrel. Moreover, in other embodiments, the positioning assembly may not include the trigger, and the movable barrel may be directly pushed to release the raising cord. Furthermore, in other embodiments, the blind may not include the handheld plate, and the raising device may be directly disposed on one of the slats that is located farthest away from the headrail. Additionally, in other embodiments, the blind may merely include one raising device.

According to the blind without pull cord and the raising device disclosed by above embodiments, since the housing of the raising device is connected to the movable side, the structure of the raising device is not limited by the headrail of the blind structure that is located at the fixed side. Therefore, the raising device is allowed to raise the movable side by the retracting component that is cheap and simple in structure without using various expensive and complex machine elements such as gears. Thus, the manufacture cost of the blind is reduced.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A blind without pull cord, comprising:
a blind structure, having a fixed side and a movable side opposite to each other; and
at least one raising device, comprising:
a housing, connected to the movable side;
a retracting component, rotatably disposed on the housing; and
a raising cord, wherein two opposite ends of the raising cord are connected to the blind structure and the retracting component, respectively, and the retracting component is configured to raise the movable side relative to the fixed side via the raising cord.

2. The blind without pull cord according to claim 1, wherein the at least one raising device further comprises a positioning assembly, the positioning assembly is disposed in the housing and configured to position or release the raising cord.

3. The blind without pull cord according to claim 2, wherein the positioning assembly comprises:
a fixed barrel, fixed to the housing and having a first through hole, wherein the first through hole extends along a radial direction of the fixed barrel; and
a movable barrel, movably disposed in the housing and having a second through hole, wherein the second through hole extends along a radial direction of the movable barrel, the raising cord is disposed through the first through hole and the second through hole, the first through hole and the second through hole are misaligned with each other along the radial direction of the fixed barrel so as to allow the raising cord to be positioned by the positioning assembly, and when the movable barrel is pushed, the first through hole and the second through hole are aligned with each other along the radial direction of the fixed barrel to allow the positioning assembly to release the raising cord.

4. The blind without pull cord according to claim 3, wherein the fixed barrel further has an accommodation through hole, the accommodation through hole extends along an axial direction of the fixed barrel and is connected to the first through hole, and the movable barrel is disposed through the accommodation through hole.

5. The blind without pull cord according to claim 3, wherein the positioning assembly further comprises a trigger, the trigger rests on a side of the movable barrel to be configured to force the positioning assembly to release the raising cord.

6. The blind without pull cord according to claim 5, wherein the housing comprises a base and a cover, the base comprises a bottom plate and a first side peripheral plate standing on the bottom plate, the cover comprises a top plate and a second side peripheral plate standing on the top plate, the second side peripheral plate is stacked on the first side peripheral plate so as to allow the base and the cover to together form an accommodation space, the retracting component, the fixed barrel and the movable barrel are located in the accommodation space, the first side peripheral plate and the second side peripheral plate together form a mounting through hole connected to the accommodation space, the trigger is disposed through the mounting through hole, the top plate has a cord hole connected to the accommodation space, and the raising cord is disposed through the cord hole.

7. The blind without pull cord according to claim 1, further comprising a handheld plate, wherein the handheld plate is connected to the movable side of the blind structure, the at least one raising device comprises two raising devices, and the two raising devices are disposed in the handheld plate and spaced apart from each other.

8. A raising device, configured to be connected to a movable side of a blind structure, the raising device comprising:
a housing, configured to be connected to the movable side;
a retracting component, rotatably disposed on the housing; and
a raising cord, wherein two opposite ends of the raising cord are connected to the blind structure and the retracting component, respectively, and the retracting component is configured to raise the movable side via the raising cord.

9. The raising device according to claim 8, further comprising a positioning assembly disposed in the housing and configured to position or release the raising cord.

10. The raising device according to claim 9, wherein the positioning assembly comprises:
a fixed barrel, fixed to the housing and having a first through hole, wherein the first through hole extends along a radial direction of the fixed barrel; and
a movable barrel, movably disposed in the housing and having a second through hole, wherein the second through hole extends along a radial direction of the movable barrel, the raising cord is disposed through the first through hole and the second through hole, the first through hole and the second through hole are misaligned with each other along the radial direction of the fixed barrel so as to allow the raising cord to be positioned by the positioning assembly, and when the movable barrel is pushed, the first through hole and the second through hole are aligned with each other along the radial direction of the fixed barrel to allow the positioning assembly to release the raising cord.
